(19) United States
(12) Patent Application Publication
(10) Pub. No.: US 2025/0283186 A1
(43) Pub. Date: Sep. 11, 2025

(54) METHOD FOR THE DIRECT REDUCTION OF IRON ORE

(71) Applicant: ThyssenKrupp Steel Europe AG, Duisburg (DE)

(72) Inventors: Nils JÄGER, Mülheim (DE); Daniel SCHUBERT, Duisburg (DE)

(73) Assignee: ThyssenKrupp Steel Europe AG, Duisburg (DE)

(21) Appl. No.: 18/289,325

(22) PCT Filed: Apr. 28, 2022
(86) PCT No.: PCT/EP2022/061332

§ 371 Date: Aug. 1, 2024

(30) Foreign Application Priority Data
May 11, 2021 (DE) 102021112208.2

(51) Int. Cl. C21B 13/00; C21B 13/02

(52) U.S. Cl. CPC C21B 13/0073; C21B 13/0033; C21B 13/029

(57) ABSTRACT

A process for direct reduction of iron ore to sponge iron is disclosed. The iron ore passes through a reduction zone for reducing the iron ore to sponge iron. A reduction gas is passed through the iron ore in the reduction zone. The reduction gas introduced into the reduction zone comprises at least one compound of carbon and hydrogen and/or at least one compound of carbon and oxygen and/or hydrogen. The process gas discharged from the reduction zone comprises hydrogen and at least one compound of carbon and oxygen and/or at least one hydrogen-containing compound. The process gas is supplied to at least a first process step in which at least one compound of the process gas and/or at least portions of the unavoidable impurities are separated and/or removed. After the first process step the process gas is subjected to processing such that hydrogen is obtained as a byproduct.

The invention relates to a process for direct reduction of iron ore to sponge iron.

The direct reduction process comprises carrying out a solid-state reaction in which oxygen is removed from the iron ore. This comprises using gasified carbon and/or natural gas/hydrocarbon-containing compounds and mixtures of the recited combinations especially with hydrogen and/or compounds of carbon and oxygen as reduction gas. The trend in recent times is that hydrogen is increasingly also being proposed as reduction gas. The reaction is carried out below the melting point of the iron ore in the solid state so that especially its inner structure remains very largely unchanged. When reducing the iron ore to the metallic product it is fundamentally only the oxygen present in the ore that is removed. Since the removal of oxygen leads to a weight reduction of about ¼ to ⅓, a honeycomb microstructure of the reaction product (solid porous iron with many air-filled interspaces) results. Therefore, the direct reduced iron is often also referred to as sponge iron. The direct reduction process classically employs a shaft furnace as the reactor with a reduction zone through which the iron ore passes counter to the reduction gas. In a special variant of the process the reduction zone is arranged above a cooling zone in the shaft furnace, wherein a cooling gas is passed through the cooling zone. The iron ore then passes through the shaft furnace in the vertical direction from top to bottom. Such shaft furnaces allow good passage of cooling gas and reduction gas through the iron ore on account of the underlying chimney effect. In particular the reduction gas is passed through the reduction zone counter to a direction of motion of the iron ore. Accordingly, the cooling gas likewise flows through the cooling zone counter to a direction of motion of the produced sponge iron. Both the cooling zone and the reduction zone are thus run in countercurrent to achieve efficient reaction between the gases and the solids.

The reduction gas employed may in particular be CO or H₂ or a mixed gas comprising CO and H₂. The reduction reactions are as follows (“( )” indicates solids; curly brackets { } indicate gaseous substances):

3(Fe₂O₃)+{CO}⇄(Fe₃O₄)+{CO₂}

(Fe₃O₄)+{CO}⇄3(FeO)+{CO₂}

(FeO)+{CO}⇄(Fe)+{CO₂}

3(Fe₂O₃)+{H₂}⇄2(Fe₃O₄)+{H₂O}

(Fe₃O₄)+{H₂}⇄(FeO)+{H₂O}

(FeO)+{H₂}⇄(Fe)+{H₂O}

The reduction gas is typically produced from fossil hydrocarbons (e.g. natural gas and/or coal gas). The reactions for methane (as the main constituent of natural gas but also biogas) as starting gas are elucidated below by way of example. Other hydrocarbons are likewise possible as starting gas. The reduction gas is produced from methane, CO₂ and steam in a gas reformer (MIDREX® process).

CH₄+CO₂⇄2CO+2H₂

CH₄+H₂O⇄CO+3H₂

This results in a gas circuit where the consumed methane is replaced by new methane mixed with the purified process gas from the shaft furnace upstream of the gas reformer. The process gas from the shaft furnace contains CO₂ and steam as products of the reduction reaction. The reduction gas H₂ and CO is produced from methane, CO₂ and steam by means of a catalytic reaction in the gas reformer. This reduction gas mixture is supplied to the shaft furnace where it reduces the iron ore according to the above reaction equations. CO₂, steam and sponge iron are formed as the substantial reaction products. CO₂ and steam and unconsumed reduction gas are mixed with methane and returned to the gas reformer.

The production of sponge iron comprises essentially two fundamental steps. A first step comprises performing the reduction of the iron ore to sponge iron in a reduction zone with a suitable hot reduction gas. A reduction gas typically comprises essentially compounds of carbon and hydrogen (for example CH₄), compounds of carbon and oxygen (for example CO) and/or hydrogen (H₂) at temperatures in the range from 700° C. to 1100° C. In a second step the produced sponge iron is cooled to temperatures typically below 100° C. using a cooling gas in a cooling zone.

Corresponding processes are known from practice and described for example in DD 153 701 A5 and EP 2 459 755 B1. DD 153 701 A5 discloses that the process gas withdrawn at the upper end of a reactor in the form of a shaft furnace is cooled and scrubbed (freed of dust) and heated in the presence of a catalyst to form a hot reformed reduction gas, said gas then being mixed with a hot sulfur-containing process gas, for example coal gas or natural gas, and the resulting reduction mixture being returned to the reactor. EP 2 459 755 B1 describes that the process gas withdrawn at the upper end of the reactor comprises hydrogen, carbon monoxide, carbon dioxide, methane and water. The withdrawn process gas is purified and cooled in a gas cooling unit to condense water and remove it from the process gas. The purified and cooled process gas is furthermore treated in a selective carbon dioxide removal unit to produce a stream of almost pure carbon dioxide which can be controllably removed, thus producing an enriched reduction gas comprising primarily hydrogen, carbon monoxide and methane. A first portion of the enriched reduction gas is recycled into the reactor once it has been heated in a reduction gas heater. A second portion of the enriched reduction gas is treated in a gas separation unit so as to produce a first gas stream having a higher concentration of hydrogen and a second gas stream having a higher concentration of carbon monoxide and methane, wherein the first gas stream is used as a fuel in the reduction gas heater and the second gas stream is recycled to the reactor. Burning the hydrogen-containing first gas stream in the reduction gas heater instead of carbon-containing fuels reduces the carbon dioxide emissions into the atmosphere.

It is an object of the present invention to develop these processes in such a way that it is possible to produce byproducts that may be used inter alia in other fields of application.

This object is achieved by a process for direct reduction of iron ore to sponge iron, wherein the iron ore passes through a reduction zone for reducing the iron ore to sponge iron, wherein a reduction gas is passed through the iron ore in the reduction zone, wherein the reduction gas introduced into the reduction zone comprises at least one compound of carbon and hydrogen and/or at least one compound of carbon and oxygen and/or hydrogen, wherein the process gas discharged from the reduction zone comprises hydrogen and at least one compound of carbon and oxygen and/or at least one hydrogen-containing compound and unavoidable impurities, wherein the process gas is supplied to at least a first process step in which at least one compound of the process gas and/or at least portions of the unavoidable impurities are separated and/or removed, wherein according to the invention after the first process step the process gas is subjected to (further) processing such that hydrogen is obtained as a byproduct which is either a) entirely supplied to the reduction zone, b) partly supplied to the reduction zone, the remaining portion being stored or provided to an ex situ use, or c) entirely stored or provided to an ex situ use.

According to the invention the direct reduction process for producing sponge iron from iron ore produces, by suitable means and processes, hydrogen (H₂) as a byproduct. In contrast to what is known in the prior art, the hydrogen is not admixed with a starting gas (make-up gas) as a mixture with other components of the purified process gas, for example CO, which is then firstly heated to the appropriate temperature as a reduction gas in a reduction gas heater before being introduced into the reduction zone, or alternatively made available as fuel gas and/or supplementary gas to the fuel gas for firing the reduction gas heater.

Unavoidable impurities in the discharged process gas may comprise, if present, not only sulfur or sulfur-containing compounds, nitrogen, nitrogen oxides, but also dusts in the form of iron and/or iron oxides, especially also other natural ore constituents. Unavoidable impurities are especially to be understood as meaning reaction products that are a consequence of the process and cannot be assigned to the compound of carbon and oxygen (CO, CO₂), hydrogen (H₂) and steam (H₂O).

An ex situ use is to be understood as meaning a use of the hydrogen obtained from the process gas outside the scope of the direct reduction process, i.e. a possible application in many other fields and precisely not a recycling into the direct reduction process (in situ).

In the first process step, in which at least one compound or component is removed and/or separated from the process gas, water in liquid form may for example be separated as a reaction product formed in a scrubber, through which the discharged process gas is passed as a first unit. Alternatively, the first process step may comprise separating at least a portion of the unavoidable impurities in the form of dusts from the discharged process gas in a process gas purification unit.

If the introduced reduction gas contains at least one compound of carbon and hydrogen, in particular methane, then in particular a methane pyrolysis where hydrogen is liberated from the methane molecule is effected in the reduction zone with the iron ore. The carbon present in the methane partly remains in the produced sponge iron in the form of deposited carbon, in particular as cementite (Fe₃C) bound in the iron, and is partly separated from the process as CO₂. A large part of the hydrogen reacts with the ore present in the reactor as a reducing agent. The unreacted proportion of the hydrogen is discharged as a portion of the process gas.

The hydrogen may if required (aspect a)) be completely recycled into the reduction zone, i.e. it is admixed with the starting gas comprising at least one compound of carbon and hydrogen, for example methane (CH₄), and/or at least one compound of carbon and oxygen, for example carbon monoxide (CO), and/or hydrogen (H₂), before the resulting mixture is supplied as reduction gas to a reduction gas heater, heated to the appropriate operating temperature and subsequently introduced into the reduction zone. The obtained hydrogen is thus entirely supplied to the reduction process (in situ).

Alternatively (aspect b)), a portion of the obtained hydrogen may be returned to the reduction zone or the reduction process as described above and the remaining portion may either be stored or provided to an ex situ use. Storage may be effected in the tanks/containers and gasometers known per se and until the corresponding use in order either to be supplied to the reduction process or otherwise to be transported to the appropriate usage location either via suitable transport containers by sea, rail, road or by pipeline. The provision to the ex situ use may either be effected into adjacent processes via a conduit or for example be fed into a public conduit to which further consumers have access.

In a further alternative (aspect c)) the hydrogen may be entirely stored as described above or provided to an ex situ use as described above.

According to the invention the process for direct reduction of iron ore to sponge iron affords hydrogen (H₂) as a by-product. This is an alternative process to the established process for hydrogen production by electrolysis.

To increase the proportion of hydrogen in the process gas the process gas may be passed through a unit in which hot steam is admixed with the process gas to allow conversion of carbon monoxide (CO) to carbon dioxide (CO₂) and hydrogen (H₂), known as the water gas shift reaction, which proceeds slightly exothermically (ΔH=−41.2 KJ/mol) with the formula:

CO+H₂O⇄CO₂+H₂.

The process gas is passed through at least one unit in which compounds of carbon and oxygen such as for example carbon dioxide (CO₂) are separated, for example by a CO₂ separation in the form of an amine scrubbing, carbonate scrubbing, various membrane separation technologies or pressure swing absorption (PSA). To further improve the climate balance the carbon dioxide (CO₂) separated from the process gas may for example be stored in a suitable environment by CCS (Carbon Capture and Storage) or sent for material utilization in the context of a CCU (Carbon Capture and Utilization) process. Furthermore, the carbon dioxide (CO₂) may also be sent for material utilization as cooling gas or as a portion of the cooling gas in an optional cooling zone in the direct reduction process.

Sulfur, which may be a constituent of the reduction gas (for example natural gas or coke oven gas), in particular as an impurity, is deposited in the sponge iron. If the already expected low sulfur contents in the process gas need to be still further reduced the process gas may optionally be passed through at least one unit in which sulfur or sulfur-containing compounds (SO₂, SO₃, H₂S and H₂SO₄) may be removed, for example by known non-regenerative processes in the form of a lime scrubbing or regenerative processes in the form of the so-called Wellman-Lord process.

The process gas is passed through at least one unit, for example through a condenser, and correspondingly cooled, so that the steam present in the process gas is condensed and thus removed from the process gas. The condensing and discharging of the condensate “dehumidifies” the process gas.

The arrangement of the individual units and the sequence in which the process gas passes through these units, and thus which compounds or components are removed and/or separated from the process gas in which order, depends on the economic efficiency and the chemical composition of the reduction gas. In particular, the sequence inter alia also depends on the intended quality of the hydrogen-rich gas. In industrial processes high purity of the hydrogen is often not mandatory, for example because no catalysts are damaged or because no high pressures are required in further use.

The processes associated with the corresponding units for removal and/or separation of individual elements, compounds or components from the discharged process gas are also prior art and thus known to those skilled in the art, so that not every process need be explicitly elucidated in detail.

It is preferable when in a first process step the process gas passes through a unit for “dedusting” and thus separation of at least a portion of the unavoidable solid-form impurities. In a further process step, the process gas is directly shifted in a water gas shift unit to achieve a high hydrogen yield. This state can result in high circulation rates which can lead for example to low sulfur contents in the process gas. Subsequently, in a further process, steam and carbon dioxide and optionally further concomitant elements such as carbon monoxide or nitrogen are removed.

Depending on the process mode and obtaining of the hydrogen the remaining portion of the process gas which contains little to no elemental hydrogen may be recycled to the reduction process, in particular as fuel gas or as supplementary gas to the fuel gas, to fire the reduction gas heater.

In one embodiment of the process the reduction gas is heated in a reduction gas heater to a temperature of at least 700° C. to at most 1100° C. so that in particular after subsequent addition of oxygen by a partial combustion the reduction gas temperature is established in the reduction zone at a temperature profile between 900° C. and 1400° C.

The starting gas provided in particular comprises as the main constituent at least one compound of carbon and hydrogen, preferably methane (CH₄). It is preferable to employ the operating mode according to aspect c), as a result of which the component(s) of the reduction gas then substantially correspond(s) to those of the starting gas. It is particularly preferable when the reduction gas comprises at least one compound of carbon and hydrogen and optionally hydrogen in a proportion of up to 30% by volume. Depending on the hydrogen content hydrocarbon compounds may be replaced by the corresponding proportion as starting gas, thus making it possible to reduce the corresponding costs of providing the starting gas.

If an admixing of hydrogen according to aspects a) or b) is carried out this can reduce the corresponding proportion in the at least one compound of carbon and hydrogen according to the admixing with the result that the reduction gas comprises hydrogen in a proportion of up to 30% by volume and the remainder comprises at least one compound of carbon. If no admixing is carried out, see aspect c), the reduction gas substantially corresponds to the provided starting gas. The carbon from the at least one compound of carbon and hydrogen in the reduction gas makes it possible to “carburize” the iron ore in the reduction zone due to the reduction gas being passed through the iron ore in the reduction zone with the result that carbon is deposited on the iron ore. The deposited carbon then combines with the iron of the iron ore to form cementite (FesC). The reaction equation for this mechanism is: 3Fe+C→Fe₃C.

The use of virtually 100% hydrogen instead of hydrocarbons for example would result in the carbon content of the produced sponge iron generally being particularly low since no side reactions with hydrocarbons which would deposit carbon in the sponge iron can occur in the reduction zone, so that a carbon content in the sponge iron of less than 0.25% by weight would be expected after the reduction zone. To be able to establish a certain carbon content in the sponge iron after the reduction a mixture of up to 30% by volume of hydrogen and at least one compound of carbon and hydrogen and/or at least one compound of carbon and oxygen in the reduction gas may also be considered.

If hot employment of the sponge iron coming from the reduction zone at a temperature between 500° C. and 800° C. is not possible, the sponge iron, in one embodiment of the process, passes through a cooling zone. The process thus provides that the iron ore sequentially passes through a reduction zone for reducing the iron ore to sponge iron and a cooling zone for cooling the sponge iron. In the cooling zone a cooling gas is passed through the sponge iron. The cooling gas is used to cool the sponge iron to a temperature suitable for further transport, for example below 100° C., and can also bring about a (further) “carburizing” of the sponge iron depending on the composition of the cooling gas, especially when carbon-containing compounds are used, preferably carbon dioxide (CO₂), which can preferably be removed from the discharged process gas from the reduction zone and not sent for CCS or CCU for example. In the case of carbon dioxide and hydrogen for example, the so-called Bosch reaction takes place in the cooling zone:

CO₂+2H₂→C+2H₂O.

Carbon dioxide can be consumed during the “carburizing” of the sponge iron under conditions prevailing therein. In the cooling zone and as a result of the cooling gas which comprises at least one carbon-containing compound the carbon content of the sponge iron after the cooling and/or after the cooling zone may be adjusted to more than 0.5% by weight, in particular more than 1.0% by weight, preferably more than 2.0% by weight. Furthermore, the carbon content of the sponge iron after the cooling zone may be adjusted to less than 4.5% by weight, in particular less than 4.0% by weight, preferably less than 3.5% by weight, which has the advantage that the sponge iron may be sent to the known further processing processes without any need to adapt the further processing processes. In particular, the sponge iron may be subjected to further processing for example in the Linz-Donawitz converter (also referred to as a “Basic Oxygen Furnace”). In addition, the melting point of the sponge iron may be reduced by increasing the carbon content. This also makes it possible to reduce the energy demand for melting in the electric arc furnace.

Thus in one variant of the process the reduction zone may be arranged above the cooling zone in a shaft furnace. The iron ore then passes through the shaft furnace in the vertical direction from top to bottom. Such shaft furnaces allow good passage of reduction gas and cooling gas through the iron ore on account of the underlying chimney effect. In particular the reduction gas is passed through the reduction zone counter to a direction of motion of the iron ore. Accordingly, the cooling gas likewise flows through the cooling zone counter to a direction of motion of the produced sponge iron. Both the reduction zone and the cooling zone are thus run in countercurrent to achieve efficient reaction between the gases and the solids.

In an alternative variant of the process the reduction zone and/or the cooling zone comprise(s) one or more fluidized bed reactors. In a fluidized bed reactor a small-particle-size solids bed is fluidized via the gas which is continuously introduced from below via a gas distributor. This likewise enables efficient reaction between the gases and the solids.

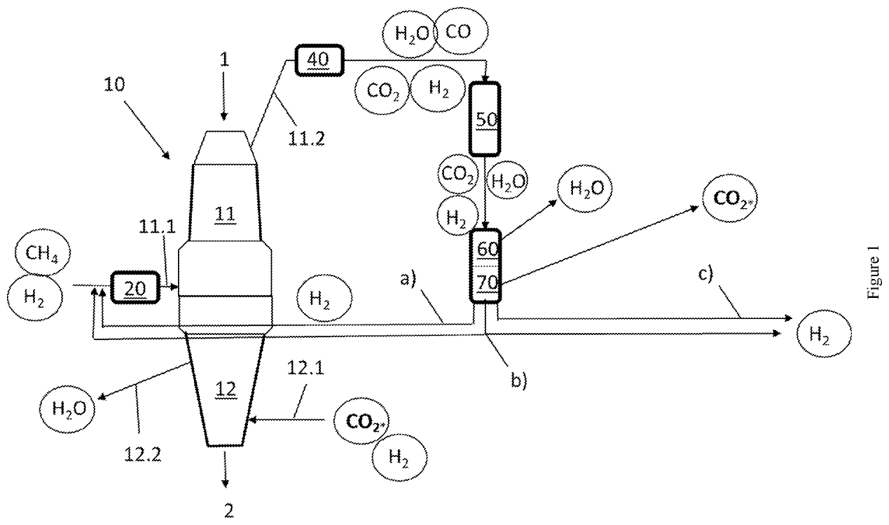

The invention is more particularly elucidated with reference to following the exemplary embodiments in conjunction with FIG. 1. FIG. 1 shows an example of a process according to the invention with reference to a schematic representation of a shaft furnace.

FIG. 1 elucidates the invention using the example of a shaft furnace (10). Iron ore (1) is introduced at the upper end of the shaft furnace (10). The produced sponge iron (2) is withdrawn at the lower end of the shaft furnace (10). The shaft furnace (10) has a reduction zone (11) and optionally a cooling zone (12) arranged in it. The reduction zone (11) is arranged above the optional cooling zone (12). The cooling zone (12) is not mandatory if hot employment of the hot sponge iron directly exiting the reduction zone (11) is possible and/or the reduction gas (11.1) introduced into the reduction zone (11) comprises at least one carbon-containing compound which not only reduces the iron ore by reaction in the reduction zone (11) but can also simultaneously achieve sufficient “carburization”. The reduction gas (11.1) is passed through the iron ore in the reduction zone (11) in countercurrent and thus counter to a direction of motion of the iron ore. Before introduction the reduction gas (11.1) is passed through a reduction gas heater (20) and heated to a temperature of up to 1100° C. but at least 700° C. The reduction gas (11) comprises at least one compound of carbon and hydrogen and/or at least one compound of carbon and oxygen and/or hydrogen. In the case that the reduction gas (11.1) contains elemental hydrogen (H₂) either the starting gas which is provided contains a corresponding proportion and/or hydrogen (H₂) obtained from the process gas (11.2) is admixed in the recycling via aspect a) or b) of the invention so that ultimately the entirety of the obtained hydrogen (aspect a)) or only a portion thereof (aspect b)) is supplied to the reduction zone (11). It is preferable when the main constituent of the starting gas is provided in the form of methane (CH₄), for example natural gas. It is further preferable when aspect c) of the invention is performed and no admixing with hydrogen (H₂) obtained from the discharged process gas (11.2) is carried out.

The reduction of the iron ore to sponge iron is carried out in the reduction zone (11). Due to the at least one compound of carbon and hydrogen and/or the at least one compound of carbon and oxygen in the reduction gas (11.1) the sponge iron exits the reduction zone (11) with a carbon content of more than 0.75% by weight.

Unconsumed reduction gas (11.1) is discharged from the reduction zone (11) together with any gaseous reaction products as process gas (11.2). The process gas (11.2) discharged from the reduction zone (11) comprises hydrogen (H₂) and at least one compound of carbon and oxygen (CO, CO₂) and/or at least one hydrogen-containing compound (H₂O) and unavoidable impurities. The process gas (11.2) is supplied to at least one first process step in which at least one compound of the process gas (11.2) and/or at least portions of the unavoidable impurities are separated and/or removed. FIG. 1 symbolically shows a unit for process gas cleaning and dedusting (30) in which at least a portion of the unavoidable impurities are separated from the discharged process gas (11.2). In a further process step the hydrogen yield is improved by a water gas shift reaction in a corresponding reactor (50) in which hot steam is supplied and the carbon monoxide (CO) present in the process gas is converted into carbon dioxide (CO₂) and hydrogen (H₂). In a further process the process gas (11.2) is passed through a unit (60), for example through a condenser, and correspondingly cooled so that the steam (H₂O) present in the process gas (11.2) is condensed and thus removed from the process gas (11.2). The condensing and discharging of the condensate “dehumidifies” the process gas (11.2). Carbon dioxide (CO₂) is subsequently separated in a further process, for example in an amine scrubbing (70) or a PSA. Alternatively the carbon dioxide (CO₂) may also be employed as cooling gas (12.1) or a portion of the cooling gas (12.1) in an optional cooling zone (12).

The hydrogen (H₂) obtained from the process gas (11.2) according to the invention may be entirely mixed with a starting gas to afford a reduction gas (11.1) and thus supplied to the reduction zone (aspect a)). It is alternatively possible for only a portion of the obtained hydrogen (H₂) to be mixed with a starting gas to afford a reduction gas (11.1) and thus supplied to the reduction zone and for the remaining portion of the obtained hydrogen (H₂) to be either stored or provided to an ex situ use (aspect b)). As a further and particularly preferred alternative the obtained hydrogen (H₂) may be entirely stored or provided to an ex situ use (aspect c)). The storage and ex situ use are not shown here.

After exiting the reduction zone (11) the sponge iron enters the optional cooling zone (12). The sponge iron has a temperature in the range from 500° C. to 800° C. In the cooling zone (12) cooling gas (12.1) is also passed through the sponge iron counter to the direction of motion of the sponge iron. Unconsumed cooling gas, together with any gaseous reaction products, is discharged again as process gas (12.2). It will be appreciated that a certain proportion of the cooling gas (12.1) may also enter the reduction zone (11). A certain proportion of the reduction gas (11.1) may likewise enter the cooling zone (12). Mixtures of cooling gas (12.1) and reduction gas (11.1) can therefore occur at the transition between the reduction zone (11) and the cooling zone (12). The cooling gas (12.1) especially comprises a carbon-containing compound, preferably carbon dioxide (CO₂). Hydrogen (H₂) may, if required, be admixed with the cooling gas (12.1), as a result of which the cooling gas (12.1) undergoes the Bosch reaction in the presence of the hot sponge iron as catalyst in the cooling zone (12).

Hydrogen (H₂) and carbon dioxide (CO₂) in the cooling gas thus react according to the Bosch reaction

CO₂+2H₂→C+2H₂O

to afford steam (H₂O) and carbon (C), wherein the carbon is deposited on the sponge iron serving as catalyst. The steam with other gaseous reaction products is discharged as process gas (12.2) from the cooling zone (12) of the shaft furnace (10). The deposited carbon then diffuses into the interior of the sponge iron and forms cementite (FesC). This effect increases the carbon content of the sponge iron to 0.5% by weight to 4.5% by weight. The sponge iron carburized and cooled in this way may be withdrawn in the lower region of the shaft furnace (10) and sent for further processing in a known manner of steel production.

Alternatively and not shown here the invention may also be performed in a cascade of fluidized bed reactors. At least one and in particular two fluidized bed reactors form a reduction zone and depending on the circumstances and if hot employment is not possible at least one further fluidized bed reactor may be used in the cascade as a cooling zone. Thus, the iron ore would successively pass through the first or the at least two fluidized bed reactors to undergo step-by-step conversion into sponge iron. If required, the last fluidized bed reactor can effect cooling of the sponge iron using cooling gas. The principle substantially corresponds to that of a shaft furnace but distributed over a plurality of fluidized bed reactors instead of a shaft. The number of fluidized bed reactors can be interconnected as required.

1. A process for direct reduction of iron ore to sponge iron, wherein the iron ore passes through a reduction zone for reducing the iron ore to sponge iron, wherein a reduction gas is passed through the iron ore in the reduction zone, wherein the reduction gas introduced into the reduction zone comprises at least one compound of carbon and hydrogen and/or at least one compound of carbon and oxygen and/or hydrogen, wherein a process gas discharged from the reduction zone comprises hydrogen and at least one compound of carbon and oxygen and/or at least one hydrogen-containing compound and unavoidable impurities, wherein the process gas is supplied to at least a first process step in which at least one compound of the process gas and/or at least portions of the unavoidable impurities are separated and/or removed, wherein after the first process step the process gas is subjected to processing such that hydrogen is obtained as a byproduct which is either
a) entirely supplied to the reduction zone,
b) partly supplied to the reduction zone, the remaining portion being stored or provided to an ex situ use, or
c) entirely stored or provided to an ex situ use.

2. The process as claimed in claim 1, wherein the reduction gas is heated to a temperature of at least 700° C. to 1100° C.

3. The process as claimed in claim 2, wherein the reduction gas comprises at least one compound of carbon and hydrogen and optionally hydrogen in a proportion of up to 30% by volume.

4. The process as claimed in claim 3, wherein the sponge iron passes through a cooling zone arranged downstream of the reduction zone in which cooling gas is passed through the sponge iron.

5. The process as claimed in claim 4, wherein the cooling gas comprises at least one carbon-containing compound which brings about a carburizing of the sponge iron.

6. The process as claimed in claim 5, wherein the carbon content of the cooled sponge iron is in the range from 0.5% by weight to 4.5% by weight.

7. The process as claimed in claim 6, wherein the reduction zone above the cooling zone is arranged in a shaft furnace and the iron ore passes through the shaft furnace in a vertical direction.

8. The process as claimed in claim 6, wherein at least one of the reduction zone and cooling zone comprises one or more fluidized bed reactors.

9. A method for direct reduction of iron ore to sponge iron, the method comprising:
passing the iron ore through a reduction zone for reducing the iron ore to sponge iron;
passing a reduction gas through the iron ore in the reduction zone, wherein the reduction gas introduced into the reduction zone comprises at least one compound of carbon and hydrogen and/or at least one compound of carbon and oxygen and/or hydrogen, wherein the process gas discharged from the reduction zone comprises hydrogen and at least one compound of carbon and oxygen and/or at least one hydrogen-containing compound and unavoidable impurities;
supplying a process gas in a first process step in which at least one compound of the process gas and/or at least portions of the unavoidable impurities are separated and/or removed; and
subsequent to the first process step, subjecting the process gas to processing such that hydrogen is obtained as a byproduct which is one of:
a) entirely supplied to the reduction zone;
b) partly supplied to the reduction zone, the remaining portion being stored or provided to an ex situ use; and
c) entirely stored or provided to an ex situ use.

10. The method as claimed in claim 1, wherein the reduction gas is heated to a temperature of at least 700° C. to 1100° C.

11. The method as claimed in claim 10, wherein the reduction gas comprises at least one compound of carbon and hydrogen and optionally hydrogen in a proportion of up to 30% by volume.

12. The method as claimed in claim 11, further comprising:
passing the sponge iron through a cooling zone arranged downstream of the reduction zone in which cooling gas is passed through the sponge iron.

13. The method as claimed in claim 12, wherein the cooling gas comprises at least one carbon-containing compound which brings about a carburizing of the sponge iron.

14. The method as claimed in claim 13, wherein the carbon content of the cooled sponge iron is in the range from 0.5% by weight to 4.5% by weight.

15. The method as claimed in claim 14, wherein the reduction zone above the cooling zone is arranged in a shaft furnace, the method further comprising:
passing the iron ore through the shaft furnace in a vertical direction.

16. The method as claimed in claim 15, wherein at least one of the reduction zone and cooling zone comprises one or more fluidized bed reactors.
